(19) United States
(12) Patent Application Publication
(10) Pub. No.: US 2007/0153313 A1
(43) Pub. Date: Jul. 5, 2007

(54) User terminal device having spooling control function and control method thereof

(75) Inventors: Yu-rim Han, Suwon-si (KR); Jae-kyoo Kang, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/528,550

(22) Filed: Sep. 28, 2006

(30) Foreign Application Priority Data
Dec. 29, 2005 (KR) 2005-134393

(51) Int. Cl. G06F 3/12

(52) U.S. Cl. 358/1.13

(57) ABSTRACT

A user terminal device having a spooling control function and a control method thereof, the user terminal device comprising a spooling part to spool print data, a monitoring part to monitor the image forming apparatus, and a driver part to compare time when the print data is input to the spooling part with present time if the image forming apparatus is determined to be available by the monitoring part, and to determine whether to process a printing job for the print data according to a comparison result between the input time and the present time. Accordingly, unnecessary print data stored in the spooler can be prevented from printing.

### CROSS-REFERENCE TO RELATED APPLICATIONS

This application claims the benefit of Korean Patent Application No. 2005-134393 filed on Dec. 29, 2005, in the Korean Intellectual Property Office, the disclosure of which is incorporated herein by reference.

### BACKGROUND OF THE INVENTION

1. Field of the Invention

Aspects of the present invention relate to a user terminal device having a spooling control function and a control method thereof. More particularly, the present invention relates to a user terminal device and a control method thereof, having a spooling control function that prints only necessary print data stored in a spooler.

2. Description of the Related Art

A printing system includes a user terminal device, such as a personal computer (PC), and an image forming apparatus, such as a printer. In general, when a print command on print data is input from a user terminal device, an image forming apparatus performs a printing job of the print data.

In a user terminal device, as a user inputs a print command through an application program, a driver converts the print data into a printable form, and the converted print data is transmitted through a spooler and an interface to an image forming apparatus.

The spooler stores the print data in a particular storage medium and outputs the data at a proper time for an image forming apparatus to perform a printing job conveniently; for example, after a printing job of previous print data is completed.

If the image forming apparatus cannot perform a printing job, such as when the image forming apparatus is off-line or an output port setting is improper, the print data cannot be normally transmitted to the image forming apparatus. As a result, the spooler stores the print data even when a user gives a print command through an application program.

If the image forming apparatus remains incapable of performing a printing job, a plurality of print data that is not transmitted to the image forming apparatus is arranged in a print queue on the spooler. If a user is unaware of these unperformed printing jobs, the plurality of print data may remain on the spooler for a long time.

Later, if the image forming apparatus becomes available, the print data accumulated on the spooler is transmitted through the interface to the image forming apparatus, and output therefrom.

At this time, unless deleted by an operation of a user, the print data accumulated on the spooler are output when the image forming apparatus becomes available, irrespective of a passage of print waiting time.

Usually, a user no longer needs print data after the passage of a long print waiting time. Accordingly, if such unnecessary print data is output, consumable products, such as toners and printing papers, may be wasted.

Because a use frequency of an image forming apparatus is usually not high, one image forming apparatus is generally connected to a plurality of user terminal devices so as to be commonly used.

If the image forming apparatus changes into a printable status after a user inputs a print command on a print data, and does not thereafter cancel the print command, an output result of the print data may be obtained by a third party if the user is unaware of the printing job.

### SUMMARY OF THE INVENTION

Aspects of the present invention provide a user terminal device that has a spooling control function determining whether to process a printing job according to a user's selection or a preset spooling waiting time with respect to print data stored in a spooler, and a control method thereof.

Additional aspects and/or advantages of the invention will be set forth in part in the description which follows and, in part, will be obvious from the description, or may be learned by practice of the invention.

According to an aspect of the present invention, there is provided a user terminal device connected to an image forming apparatus, the device comprising a spooling part to spool print data, a monitoring part to monitor the image forming apparatus, and a driver part to compare an input time when the print data is input to the spooling part with a present time if the image forming apparatus is determined to be available by the monitoring part, and to determine whether to process a printing job for the print data according to a comparison result between the input time and the present time.

The monitoring part may, although not necessarily, be one of a smart panel or a language monitor.

The driver part may, although not necessarily, provide a user interface to receive spooling waiting time from a user.

The driver part may, although not necessarily, control the print data to be deleted if the comparison result is greater than the spooling waiting time, and controls the print data to be printed if the comparison result is not greater than the spooling waiting time.

The driver part may, although not necessarily, ask through the user interface whether to process the printing job if the comparison result is not greater than the spooling waiting time, and control the printing job to be processed only if the user selects to process the printing job.

The device may, although not necessarily, further comprise an image forming apparatus interface part to provide an interface between the user terminal device and the image forming apparatus. The monitoring part may, although not necessarily, monitor the image forming apparatus using information on a status of the image forming apparatus received through the image forming apparatus interface part.

According to another aspect of the present invention, there is provided a method of controlling a user terminal device having a spooling part to spool print data, the method comprising operations of monitoring an image forming apparatus connected to the user terminal device, comparing an input time when the print data is input to the spooling part with a present time if the image forming apparatus is determined to be available by the monitoring, and determining whether to process a printing job for the print data according to a comparison result between the input time and the present time.

The method may, although not necessarily, further comprise an operation of receiving spooling waiting time from a user.

The print data may, although not necessarily, be controlled to be deleted if the comparison result is greater than the spooling waiting time, and the print data may be controlled to be printed if the comparison result is not greater than the spooling waiting time.

A user may, although not necessarily, be asked whether to process the printing job if the comparison result is not greater than the spooling waiting time, and the printing job may be controlled to be processed only if the user selects to process the printing job.

The monitoring may, although not necessarily, be performed using information on a status of the image forming apparatus received from the image forming apparatus.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a user terminal device having a spooling control function according to an embodiment of the present invention;

FIG. 2 is a view to explain functions of a driver part of an image forming apparatus of FIG. 1;

FIGS. 3A through 3C are views to explain functions of a spooling part of FIG. 1; and

FIG. 4 is a flowchart to explain a control method of a user terminal device having a spooling control function according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

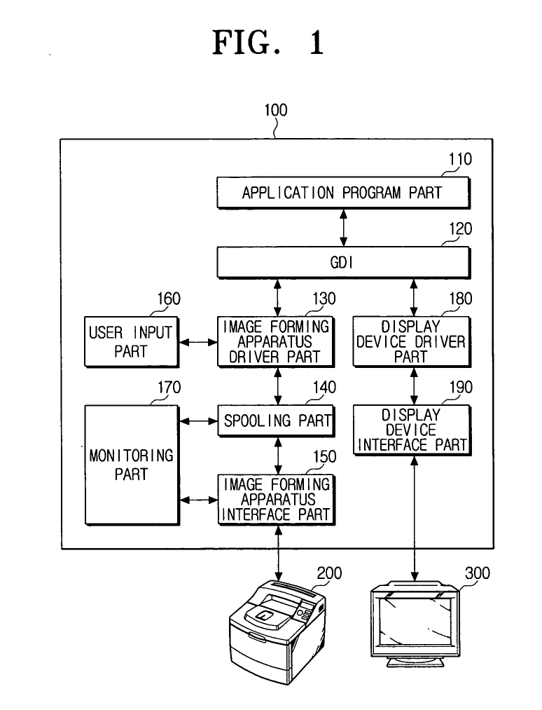

FIG. 1 is a block diagram of a user terminal device having a spooling control function according to an embodiment of the present invention.

Referring to FIG. 1, a user terminal device 100 according to an embodiment of the present invention comprises an application program part 110, a graphic device interface (GDI) 120, an image forming apparatus driver part 130, a spooling part 140, an image forming apparatus interface part 150, a user input part 160, a monitoring part 170, a display device driver part 180, and a display device interface part 190.

The application program part 110 reads a document generated by an operation of a user or a pre-generated document to give a print command on the document.

The GDI 120 provides an interface between the application program part 110 and the image forming apparatus driver part 130, and between the application program part 110 and the display device driver part 180. Print data is transmitted from the application program part 110 through the GDI 120 to the image forming apparatus driver part 130, and display data is transmitted from the application program part 110 through the GDI 120 to the display device driver part 180.

The image forming apparatus driver part 130 is a general driver program that converts the print data received through the GDI 120 from the application program part 110 into data readable by the image forming apparatus 200. The print data converted by the image forming apparatus driver part 130 is transmitted through the spooling part 140 and the image forming apparatus interface part 150 to the image forming apparatus 200.

If the image forming apparatus 200 is determined to be available by the monitoring part 170, the image forming apparatus driver part 130 compares an input time in which the print data is input into the spooling part 140 with a present time.

As a result of the comparison, the image forming apparatus driver part 130 determines whether or not the print data is printed. Here, if the difference between the input time and the present time exceeds a preset spooling waiting time, the image forming apparatus driver part 130 deletes the print data stored in the spooling part 140. Additionally, if the difference between the input time and the present time does not exceed the spooling waiting time, the image forming apparatus driver part 130 processes a printing job of the print data.

The image forming apparatus driver part 130 provides a user interface supporting an interface between a user and the image forming apparatus 200 so that a user can set functions provided in the image forming apparatus 200.

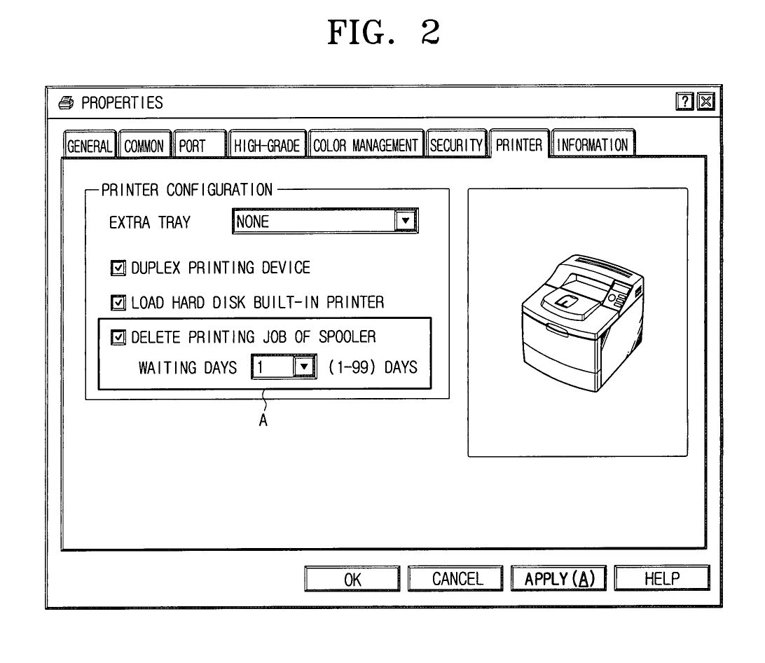

The user interface comprises various menus to select and configure functions provided in the image forming apparatus 200. The user interface may, although not necessarily, further comprise a menu to input the spooling waiting time. The user interface is displayed through the display device driver part 180 and the display device interface part 190 on the display device 300. The user interface will be explained in more detail with reference to FIG. 2.

If the difference between the input time and the present time does not exceed the spooling waiting time, the image forming apparatus driver part 130 may, although not necessarily, display through the user interface a message asking a user whether to process the printing job. Thereafter, the image forming apparatus driver part 130 can control the printing job so that the printing job is processed only if a user selects to process the printing job.

The spooling part 140 is a general spooler to spool the print data received from the image forming apparatus driver part 130. Generally, the spooler is a program to manage a spooling; for example, to store the data in a print queue and to print the data one by one. The spooling part 140 holds the input print data until the input print data is printed, the image forming apparatus driver part 130 deletes the input print data, or a user directly gives a deletion command.

If the print data is received from the image forming apparatus driver part 130, the spooling part 140 transmits the print data through the image forming apparatus interface part 150 to the image forming apparatus 200 only if the image forming apparatus 200 is available.

If the print data is received from the image forming apparatus driver part 130 but the image forming apparatus 200 is unavailable, the spooling part 140 does not transmit the print data, but holds it.

The image forming apparatus interface part 150 provides an interface between the user terminal device 100 and the image forming apparatus 200. The image forming apparatus interface part 150 transmits the print data received from the spooling part 140 to the image forming apparatus 200.

The user input part 160 provides the interface between the user and the user terminal device 100. The user input part 160 receives a setting value input by a user through the user interface provided in the image forming apparatus driver part 130, and inputs the value into the image forming apparatus driver part 130.

The monitoring part 170 monitors the spooling part 140 and the image forming apparatus 200. The monitoring part 170 may be one of a smart panel or a language monitor.

The monitoring part 170 can monitor the image forming apparatus 200 using status information of the image forming apparatus 200 received through the image forming apparatus interface part 150. The monitoring result of the monitoring part 170 is applied to determine whether the image forming apparatus 200 is available.

The display device driver part 180 converts the display data input through the application program part 110 and the GDI 120 into a data form displayable on the display device 300 to transmit the data to the display device interface part 190.

The display device interface part 190 provides an interface between the user terminal device 100 and the display device 300. The display device interface part 190 transmits the data converted by the display device driver part 180 to the display device 300.

The image forming apparatus 200 processes a printing job of the print data according to a print command received from the user terminal device 100. The image forming apparatus 200 can be any of, although not limited to, a printer or a multifunctional peripheral device.

The display device 300 displays the data according to a display command received from the user terminal device 100. In the present embodiment, the user interface provided by the image forming apparatus driver part 130 may be displayed on the display device 300.

FIG. 2 is a view to explain functions of the image forming apparatus driver part of FIG. 1.

As shown, the user interface provided by the image forming apparatus driver part 130, through the display device driver part 180 and the display device interface part 190, is displayed on the display part 300 so that a user can select necessary functions.

The user interface may comprise menu tabs for each function including, but not limited to, a “general” tab, a “common” tab, a “port” tab, a “high grade” tab, a “color management” tab, a “security” tab, a “printer” tab, and an “information” tab.

In the present embodiment, the “printer” tab comprises a menu option A to “delete printing job of spooler” and to set “waiting days.” If a check box of “delete printing job of spooler” is checked, the print data held in the spooling part for a period longer than a set spooling waiting time is deleted by the image forming apparatus driver part 130. If the check box of “delete printing job of spooler” is off, the “waiting days” can not be set.

Here, the “waiting days” refer to a spooling waiting time, and are shown as being set by a day unit from 1 to 99. However, the spooling waiting time may be set by any incremental units, including a minute unit or an hour unit.

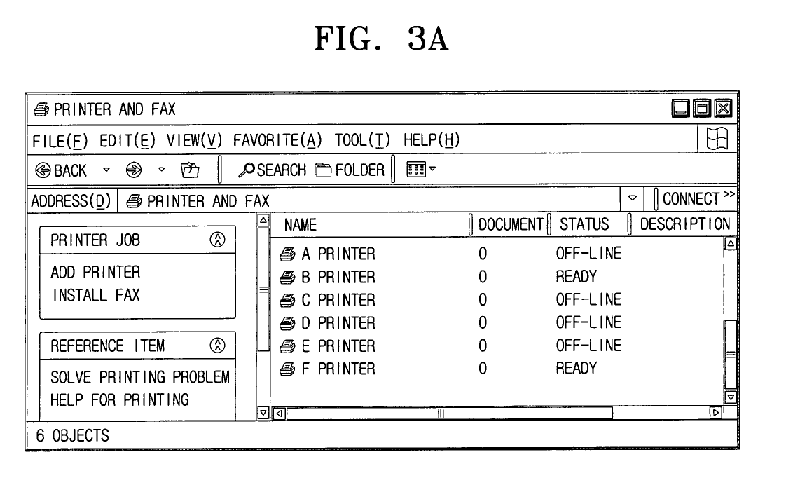

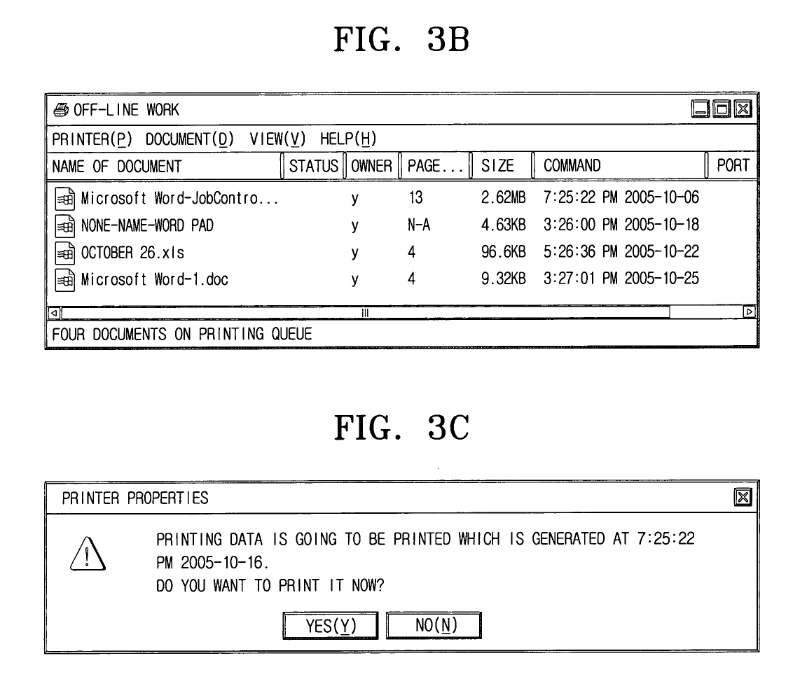

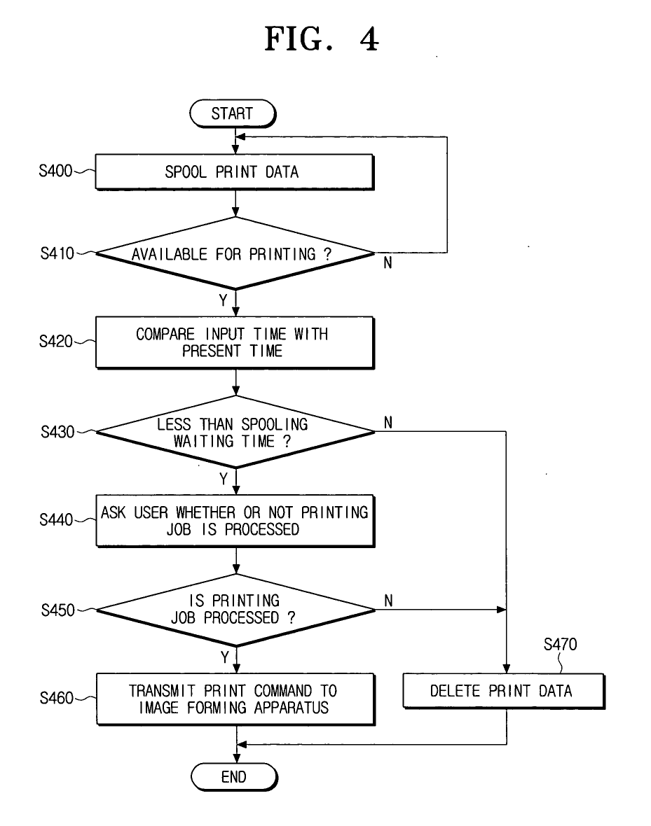

FIGS. 3A through 3C are views to explain functions of the spooling part of FIG. 1.

FIG. 3A illustrates printer properties. The printer properties include information on printers connected to the user terminal device 100. In the present embodiment, the user terminal device 100 is connected to printers A through F. The printers A, C, D and E are “off-line,” so they are unavailable to process printing jobs, and the printers B and F are “ready,” so they are available to process printing jobs.

If a user inputs a print command from the application program part 110 to the printer B, the print data is transmitted from the application program part 110 through the GDI 120, the image forming apparatus driver part 130, the spooling part 140, and the image forming apparatus interface part 150 to the image forming apparatus 200.

However, if a user inputs a print command from the application program part 110 to the printer A, the print data is transmitted through the image forming apparatus driver part 130 to the spooling part 140. According to a monitoring result of the monitoring part 170, the print data is not transmitted to the image forming apparatus 200, but stored in the spooling part 140.

If a user inputs a print command from the application program part 110 to a certain printer, the print data is input through the image forming apparatus driver part 130 into the spooling part 140. At this time, if the printer to be printed is off-line or otherwise unavailable, the printing job cannot be performed.

Accordingly, the printing job is stored in the spooling part 140 that corresponds to the selected printer, and the spooling part 140 holds the printing job as shown in FIG. 3B until the printer is available. Referring to FIG. 3B, the spooling part 140 holds four print data corresponding to one certain printer.

Thereafter, if the image forming apparatus 200 is converted from an off-line status to an available status, the image forming apparatus driver part 130 displays through the user interface a message asking a user whether to process the printing job, as shown in FIG. 3C.

Referring to FIG. 3C, a user can recognize there is print data that has previously received a print command but has not been printed by the simple information displayed, “7:25:22 PM 2005-10-16,” and a user can determine whether to print the print data.

FIG. 4 is a flowchart of a control method of a user terminal device having a spooling control function according to an embodiment of the present invention.

Here, the control method of the user terminal device 100 having the spooling control function according to an embodiment of the present invention will be explained with reference to FIGS. 1 through 4.

The spooling part 140 spools the print data received from the image forming apparatus driver part 130. The print data may be one that is newly generated by the application program part 110 and converted by the image forming apparatus driver part 130, or one that is previously received from the image forming apparatus driver part 130 and stored (S400).

The monitoring part 170 receives the status information of the image forming apparatus 200 from the image forming apparatus 200 through the image forming apparatus interface part 150, and monitors the image forming apparatus 200 using the status information. As a result of the monitoring, the image forming apparatus driver part 130 determines whether the image forming apparatus 200 is available (S410).

In the operation S410, if the image forming apparatus 200 is determined to be available, the image forming apparatus driver part 130 compares an input time when the print data is input to the spooling part 140 with a present time (S420).

Using a comparison result, the image forming apparatus driver part 130 determines whether the difference between the input time and the present time is greater than the preset spooling waiting time. The preset spooling waiting time is set by a user (S430).

In the operation S430, if the difference between the input time and the present time is not greater than the preset spooling waiting time, the image forming apparatus driver part 130 asks a user through the user interface whether to process the printing job (S440).

Accordingly, a user can determine whether the printing job for the print data stored in the spooling part 140 is processed. If a user selects to process the printing job, the image forming apparatus driver part 130 transmits the print data through the spooling part 140 to the image forming apparatus interface part 150, and the image forming apparatus interface part 150 transmits the print data to the image forming apparatus 200 (S450 through S460).

If a user selects not to process the printing job in the operation S450, the image forming apparatus driver part 130 deletes the print data of the spooling part 140, as the print data is no longer necessary (S470).

As described above, if the image forming apparatus 200 is unavailable, for example, off-line or has an improper port setting, unnecessary print data due to a passage of time can be prevented from unknowingly printing even though a user does not delete the print data accumulated in the spooling part 140 one by one.

In other words, if a user terminal device 100 having a spooling control function according to an embodiment of the present invention and a control method thereof is applied, a user's selection or the preset spooling waiting time control whether the print data stored in the spooler is processed. Accordingly, printing unnecessary print data can be avoided.

Additionally, a user is asked whether to process the printing job before the printing job is processed so that the printing job caused by an operation error can be prevented. Accordingly, the wasting of printing consumable products used for an unnecessary printing job can be prevented.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A user terminal device connected to an image forming apparatus, the device comprising:
a spooling part to spool print data;
a monitoring part to monitor the image forming apparatus; and
a driver part to determine a comparison result by comparing an input time when the print data is input to the spooling part with a present time if the image forming apparatus is determined to be available by the monitoring part, and to determine whether to process a printing job of the print data according to the comparison result.

2. The device as claimed in claim 1, wherein the monitoring part is one of a smart panel or a language monitor.

3. The device as claimed in claim 1, wherein the driver part provides a user interface to a display device to receive spooling waiting time from a user.

4. The device as claimed in claim 3, wherein the driver part controls the print data to be deleted if the comparison result is greater than the spooling waiting time, and the driver part controls the print data to be printed if the comparison result is not greater than the spooling waiting time.

5. The device as claimed in claim 1, wherein, if the print data is spooled and once the image forming apparatus is determined to be available by the monitoring part, the driver part asks the user, through a user interface, whether to process the printing job, and controls the printing job to be processed only if the user selects to process the printing job.

6. The device as claimed in claim 3, wherein, if the comparison result is not greater than the spooling waiting time, the driver part asks the user, through the user interface, whether to process the printing job, and controls the printing job to be processed only if the user selects to process the printing job.

7. The device as claimed in claim 3, wherein the user interface comprises:
a “general” menu tab;
a “common” menu tab;
a “port” menu tab;
a “high grade” menu tab;
a “color management” menu tab;
a “security” menu tab;
a “printer” menu tab; and
an “information” menu tab.

8. The device as claimed in claim 1, wherein the driver part converts the print data into data readable by the image forming apparatus.

9. The device as claimed in claim 1, wherein the driver part transmits the print data to the spooling part, and the spooling part stores the print data, deletes the print data, or transmits the print data to the image forming apparatus, according to the comparison result or a user command.

10. The device as claimed in claim 1, further comprising:
an image forming apparatus interface part to provide an interface between the user terminal device and the image forming apparatus,
wherein the monitoring part monitors the image forming apparatus using information on a status of the image forming apparatus received through the image forming apparatus interface part.

11. The device as claimed in claim 1, further comprising:
an application program part to read a document generated by an operation of a user or a pre-generated document, and to give a print command thereon;
a display device interface part to provide an interface between the user terminal device and a display device;
a display device driver part to convert display data input through the application program part into a data form displayable on the display device, and to transmit the display data to the display device interface part;
a graphic device interface to provide an interface between the application program part and the driver part, and an interface between the application program part and the display device driver part; and
a user input part to provide an interface between the user and the user terminal device.

12. A method to control a user terminal device comprising a spooling part to spool print data, the method comprising:
monitoring an image forming apparatus connected to the user terminal device;
determining a comparison result by comparing an input time when the print data is input to the spooling part with a present time if the image forming apparatus is determined to be available by the monitoring; and
determining whether to process a printing job of the print data according to the comparison result.

13. The method as claimed in claim 12, further comprising:
receiving spooling waiting time from a user, wherein the print data is controlled to be deleted if the comparison result is greater than the spooling waiting time, and the print data is controlled to be printed if the comparison result is not greater than the spooling waiting time.

14. The method as claimed in claim 13, wherein the user is asked whether to process the printing job if the comparison result is not greater than the spooling waiting time, and the printing job is controlled to be processed only if the user selects to process the printing job.

15. The method as claimed in claim 12, wherein the monitoring is performed using information on a status of the image forming apparatus received from the image forming apparatus.

16. A user terminal device connected to an image forming apparatus, the device comprising:
a driver part to determine a comparison result by comparing an input time when print data is transmitted thereto with a present time if the image forming apparatus is determined to be available, and to determine whether to process a printing job of the print data according to a comparison result between the input time and the present time.

17. The device as claimed in claim 16, further comprising:
a spooling part to, according to the comparison result or a user command, selectively spool the print data transmitted thereto by the driver part, selectively delete the print data transmitted thereto by the driver part, or selectively transmit the print data transmitted thereto by the driver part to the image forming apparatus.

18. The device as claimed in claim 16, wherein the driver part provides a user interface to a display device to receive spooling waiting time from a user, and the driver part controls the print data to be deleted if the comparison result is greater than the spooling waiting time, and the driver part controls the print data to be printed if the comparison result is not greater than the spooling waiting time.

19. The device as claimed in claim 16, wherein, if the print data is spooled and once the image forming apparatus is determined to be available by the monitoring part, the driver part asks the user, through a user interface, whether to process the printing job, and controls the printing job to be processed only if the user selects to process the printing job.

20. The device as claimed in claim 18, wherein, if the comparison result is not greater than the spooling waiting time, the driver part asks the user, through the user interface, whether to process the printing job, and controls the printing job to be processed only if the user selects to process the printing job.

21. The device as claimed in claim 18, wherein, if the comparison result is greater than the spooling waiting time, the driver part asks the user, through the user interface, whether to delete the printing job, and controls the printing job to be deleted only if the user selects to process the printing job.

22. The device as claimed in claim 18, wherein the user interface comprises:
a “general” menu tab;
a “common” menu tab;
a “port” menu tab;
a “high grade” menu tab;
a “color management” menu tab;
a “security” menu tab;
a “printer” menu tab; and
an “information” menu tab.

23. The device as claimed in claim 16, wherein the driver part converts the print data into data readable by the image forming apparatus.

24. The device as claimed in claim 16, further comprising:
a monitoring part to monitor the image forming apparatus; and
an image forming apparatus interface part to provide an interface between the user terminal device and the image forming apparatus;
wherein the monitoring part monitors the image forming apparatus using information on a status of the image forming apparatus received through the image forming apparatus interface part.

25. The device as claimed in claim 24, wherein the monitoring part is one of a smart panel or a language monitor.

26. The device as claimed in claim 16, further comprising:
an application program part to read a document generated by an operation of a user or a pre-generated document, and to give a print command thereon;
a display device interface part to provide an interface between the user terminal device and a display device;
a display device driver part to convert display data input through the application program part into a data form displayable on the display device, and to transmit the display data to the display device interface part;
a graphic device interface to provide an interface between the application program part and the driver part, and an interface between the application program part and the display device driver part; and
a user input part to provide an interface between the user and the user terminal device.
